(19) United States
(12) Patent Application Publication
(10) Pub. No.: US 2026/0035604 A1
(43) Pub. Date: Feb. 5, 2026

(54) Heat Transfer Fluids, and Use of Such Fluids

(71) Applicant: Haydale Graphene Industries PLC, Ammanford (GB)

(72) Inventors: John-Mark Seymour, Ammanford (GB); Elliot Owen Jones, Carmarthenshire (GB)

(21) Appl. No.: 19/114,770

(22) PCT Filed: Sep. 22, 2023
(86) PCT No.: PCT/EP2023/076272

§ 371 Date: Mar. 24, 2025

(30) Foreign Application Priority Data
Sep. 23, 2022 (GB) 2213894.5

(51) Int. Cl. C09K 5/10; C01B 32/194; C01B 32/21

(52) U.S. Cl. CPC C09K 5/10; C01B 32/194; C01B 32/21; C01B 2204/24

(57) ABSTRACT

The present invention relates to heat transfer fluids, particularly in the context of heating and cooling systems. Specifically, the invention relates to the use of surface-functionalised graphene particles in heat transfer fluids. Provided is a use of surface-functionalised graphene particles to improve the thermal performance of a heat transfer fluid, a heat transfer fluid comprising surface-functionalised graphene particles in a base fluid, a thermal management system comprising the heat transfer fluid, and a method of making a heat transfer fluid comprising dispersing surface-functionalised graphene particles in a base fluid.

### TECHNICAL FIELD

This application relates to heat transfer fluids, in particular for use in improving the efficiency of heating systems such as domestic central heating systems.

### BACKGROUND

Central heating systems commonly rely on heating a heat transfer fluid (alternatively referred to as a “thermal fluid”) and circulating this through one or more radiators. The heat transfer fluid is water, sometimes containing additives to boost performance. For example, ethylene glycol may be added to broaden the temperature range at which the heat transfer fluid is liquid, so as to reduce the risk of damage through freezing. In addition, inhibitors may be added to prevent mineral deposition (such as limescale) and rusting, which would otherwise create particulates which can cause blockages and sedimentation in the system over time. Generally, such systems are left for long periods of time, passing through multiple heating and cooling cycles, with little or no monitoring or replacement of the heat transfer fluid.

Heat transfer fluids also find applications in other fields, such as in radiators for engines, cooling of electronic equipment (such as computer processors and solar panels), as well as cooling of industrial equipment.

An example of a specific heat transfer fluid is given in WO 2014/068367, which relies on a particular combination of monoethylene glycol, glycerin and triethanolamine to achieve improvements in energy saving.

Recently, it has been proposed to include particulate additives to improve the thermal properties of heat transfer fluid. These particulates can boost the efficiency of heat transfer, by increasing the heat absorption and decreasing the heat loss of the fluid. However, such particulates can also lead to changes in the viscosity which increase the energy required to pump the heat transfer fluid through the heating system, potentially negating (at least in part) any energy savings from improved heat transfer. Therefore, the identification of suitable particulate additives is not straightforward.

For example, US 2011/001081 proposes the use of ceramic nanoparticles to enhance thermal performance of a base fluid, which it says provides improvements over earlier work using metallic nanoparticles (due to lower levels of surface oxidation and better chemical stability) whilst only leading to a modest increase in viscosity of the base fluid. Although the document proposes ceramics in general, it notes that such materials typically have low thermal conductivities (see paragraph of US 2011/001081). Accordingly, it focusses on silicon carbide, noting that this has one of the highest bulk thermal conductivities among ceramics (see paragraph [0040]). The silicon carbide was found to coat the inner metal surfaces of the heating system (see paragraph [0063]), with the coating not contributing to heat transfer.

Separately, WO 2020/035705 proposes the use of oxidised boron nitride as a filler for thermal fluids.

As the world looks to reduce the amount of fuel (in particular gas) used in heating, for environmental, economic and political reasons, there remains a pressing need to provide alternative and improved heat transfer fluids.

### SUMMARY OF THE INVENTION

The present proposals are based around the use of surface-functionalised graphene particles to boost the performance of a heat transfer fluid. The term “heat transfer fluid” is a term of art, which refers to fluid that takes part in heat transfer by serving as an intermediary in cooling on one side of a process, transporting and storing thermal energy, and heating on another side of a process. In this instance, the fluid is a liquid, so may be referred to as a “heat transfer liquid”. The heat transfer fluid may be used both for heating and cooling systems.

In a first aspect, the present invention provides use of surface-functionalised graphene particles to improve the thermal performance of a heat transfer fluid.

Advantageously, graphene particles are excellent heat conductors. Measured in-plane thermal conductivity of graphene generally lies in the range of 3000-5000 W/mK, which compares to 120 W/mK for silicon carbide (see paragraph of US 2011/001081) and 600 W/mK for surface thermal conductivity of boron nitride (see Table 1 on page 2 of WO 2020/035705). This allows the attainment of excellent heat transfer performance of the heat transfer fluid when used in thermal management systems.

In addition, through providing surface functionalisation on the graphene, the particles are able to disperse in a relatively straightforward manner in water during manufacture and (importantly) remain in dispersion for long periods. In addition, the present inventors have found that the surface-functionalised graphene particles show only limited (or no) coating of parts of heating/cooling systems, avoiding waste of the material and reducing the risks caused by unwanted agglomeration and deposits.

Furthermore, graphene can have other useful properties. For example, graphene particles as described herein can have a relatively low propensity to cause wear of components of the thermal management system, such as pump impellers. In addition, surface-functionalised graphene particles (in particular, oxygen-functionalised graphene particles) can have antimicrobial properties, preventing unwanted growth of microbes in the heat transfer fluid.

To achieve these effects, the surface-functionalised graphene particles preferably have oxygen-based functional groups or surfactant molecules attached to their surface, preferably through covalent bonding.

In a second aspect, the present invention provides use of a dispersion of surface-functionalised graphene particles to improve the thermal performance of a thermal management system. The thermal management system may be, for example, a central heating system, such as a domestic central heating system.

In a third aspect, the present invention provides a heat transfer fluid comprising graphene particles dispersed in a base fluid, wherein the graphene particles have oxygen-based functional groups covalently bonded to their surface. Suitably, the surface oxygen level is between 1 to 20 atom %, most preferably 3 to 9 atom %. Preferably, the oxygen-based functional groups are one or more of phenolic, hydroxy, epoxy and/or carboxylate groups.

In a fourth aspect, the present invention provides a heat transfer fluid comprising graphene particles dispersed in a base fluid, wherein the graphene particles have surfactant bound (preferably covalently bound) to their surface. The surfactant may be an anionic, cationic or non-ionic surfactant.

In a fifth aspect, the present invention provides a thermal management system, comprising a heat transfer fluid comprising surface-functionalised graphene particles dispersed in a base fluid. The thermal management system may comprise a closed-circuit operating system, e.g. a closed loop having a heater fluidly connected to one or more radiators, wherein the closed loop is filled with a heat transfer fluid as defined herein. The thermal management system may be used for heating. Alternatively, the thermal management system may be used for cooling. The thermal management system may be, for example, a central heating system, such as a domestic central heating system. Preferably, the surface-functionalised graphene particles are according to the third or fourth aspects of the invention, as set out above.

### BRIEF DESCRIPTION OF THE FIGURES

The present proposals are now explained further with reference to the accompanying figures in which:

FIG. 1 is a diagram showing oxygen functional groups at the surface of a layer of graphene.

### DETAILED DESCRIPTION OF THE INVENTION

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below. Unless clearly indicated otherwise, use of the terms “a,” “an,” and the like refers to one or more.

### Surface Functionalised Graphene Particles

The invention is based on the discovery that graphene particles can be used to boost the performance of a heat transfer fluid, provided that the surface chemistry of the graphene particles is carefully tuned to boost dispersibility (to address the poor water-dispersibility of non-functionalised graphene) whilst retaining good thermal conductivity.

The surface-functionalised graphene particles, are graphene particles which have had functional groups introduced to their surfaces (including faces or edges). Unless the context requires others, any reference to “graphene particles” is used synonymously with “surface-functionalised graphene particles”.

The graphene particles may take the form of monolayer graphene (i.e. a single layer of carbon) or multilayer graphene (i.e. particles consisting of multiple stacked graphene layers). Multilayer graphene particles may have, for example, an average (mean or median) of 2 to 100 graphene layers per particle. When the graphene particles have 2 to 5 graphene layers per particle, they can be referred to as “few-layer graphene” particles.

The number of layers of a graphene particle can be determined by counting the number of layers in transmission electron microscopy (TEM) images. Alternatively, the number of layers may be determined by Raman spectroscopy, through comparison of the 2D and G peak intensity. Both methodologies are described in Kumar et al. “Estimation of Number of Graphene Layers Using Different Methods: A Focused Review”, Materials 2021, 14, 4590.

Preferably, the median number of layers of the surface-functionalised graphene particles is between 1 and 10, more preferably between 1 and 5. Most preferably, the graphene particles are predominantly (at least 50%, at least 60%, at least 70%, at least 80%, more preferably at least 90%) single layer graphene particles.

The surface-functionalised graphene particles may take the form of plates, flakes, sheets and/or ribbons of multilayer graphene material, referred to herein as “graphene nanoplatelets” (the “nano” prefix indicating thinness, instead of the lateral dimensions).

The surface-functionalised graphene particles may take the form of platelets having a thickness less than 100 nm and a major dimension (length or width) perpendicular to the thickness. The major dimensions may be measured using TEM. The platelet thickness is preferably less than 20 nm, preferably less than 10 nm, preferably less than 5 nm (this is based on >90% of the particles (d90) having these properties, measured using light scattering by a Mastersizer). The major dimension is preferably at least 10 times, more preferably at least 100 times, more preferably at least 1,000 times, more preferably at least 10,000 times the thickness. In a particular preferred combination, the graphene particles are few layered graphene particles having a major dimension at least 500 times, preferably at least 1000 times the thickness. The aspect ratio may be determined by measuring the median thickness of a representative sample of the graphene particles by TEM, and the median length of a representative sample of the graphene particles by TEM, with the aspect ratio calculated based on these median values. Advantageously, using graphene particles with a relatively high aspect ratio can permit their inclusion at relatively low loading levels, meaning that a boost in thermal performance can be achieved without causing major changes in viscosity of the base fluid.

The graphene particles have a relatively high length: width ratio. For example, the length may be at least 1 times, at least 2 times, at least 3 times, at least 5 times or at least 10 times the width.

The d90 of the graphene particles may be 5 μm or less, 4 μm or less, 3 μm or less, 2 μm or less, preferably 1 μm or less, more preferably 500 nm or less. The d90 may be determined by light scattering using a Mastersizer.

Optionally, the graphene particles may have a multimodal size distribution. This may be achieved by combining two different samples of graphene particles having different size measurements. For example, the graphene particles may have a first peak in size distribution between 0.1 and 1 μm, and a second peak in size distribution above 1 μm, such as a first peak around 0.3 to 0.6 μm and a second peak around 1.5 to 2 μm, as determined by light scattering.

### Oxygen Functionalisation

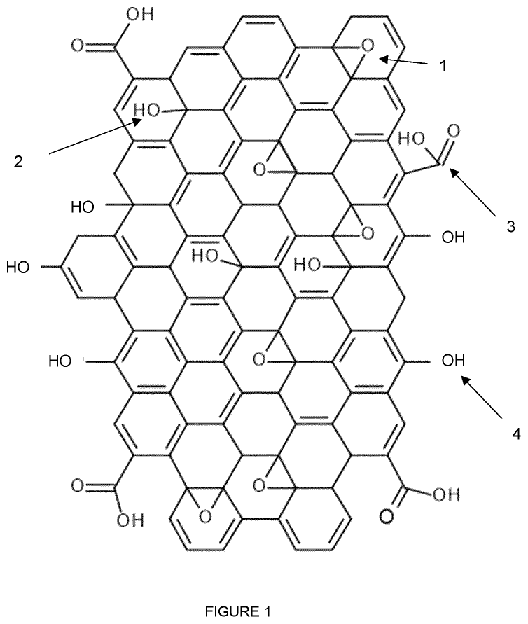

Preferably, the surface-functionalised graphene particles have oxygen-based functional groups attached to their surface. These may be referred to as “oxygen-functionalised graphene particles”. Most preferably the functional groups present on the surface of the graphene are phenolic, hydroxyl groups, epoxy and/or carboxylate groups. FIG. 1 is a schematic figure showing a layer of graphene incorporating oxygen-based functional groups, including epoxy 1, hydroxyl 2, carboxy 3 and phenoxy 4.

Advantageously, the present inventors have found that oxygen groups at the surface boost dispersibility (both during initial manufacture, and during long term use), and lead to limited propensity for the graphene to coat components of the thermal management system. Oxygen functional groups can also display anti-microbial properties.

Optionally, the oxygen moieties are covalently attached to the graphene surface through an organic linker moiety, for example, a hydrocarbon group. However, preferably, the oxygen-based functional groups are directly covalently bonded to the graphene particle surface, e.g. corresponding to phenolic, hydroxy, epoxy and/or carboxylate moieties directly bonded to the graphene particle surface, as shown schematically in FIG. 1.

The surface coverage of functional groups in the surface-functionalised graphene particles may be determined by measuring the atomic weight % of the added functionality using XPS compared to the unfunctionalised material. The total surface area of the graphene particles is calculated using the BET isotherm method (gas adsorption).

It has been found that if the level of oxygen-functionalisation is too high, this can adversely affect the thermal conductivity of the graphene particles (graphene oxide is significantly less thermally conductive than graphene). However, if the oxygen-functionalisation level is too low, this can result in poorer dispersibility in water, leading to more/faster sedimentation.

With this in mind, it is preferred that surface-functionalised graphene particles have a level of oxygen functionalisation between 1 to 20 atom %, preferably from 1.5 to 15 atom %, more preferably from 2 to 10 atom %, most preferably from 3 to 9 atom %, for example from 4 to 8 atom %, as determined by XPS. In particular, the level of 3 to 9 atom % is found to achieve a good balance between thermal conductivity and dispersibility. This applies, in particular, to when the oxygen-based functional groups are directly covalently bonded to the graphene particle surface, e.g. corresponding to phenolic, hydroxy, epoxy and/or carboxylate groups directly bonded to the graphene particle surface.

Certain other types of surface groups may be undesirable, either because they reduce dispersibility of the surface-functionalised graphene particles in water or because they negatively impact thermal conductivity. Thus, preferably, carbon and oxygen account for at least 95 atom % of the oxygen-functionalised graphene particles, more preferably at least 96 atom %, more preferably at least 97 atom % more preferably at least 98 atom %, most preferably at least 99 atom %.

Any suitable type of functionalisation process can be used to achieve the desired oxygen functionalisation. However, preferably oxygen functionalisation is obtainable by plasma treatment of a suitable precursor (e.g. graphite particles) with an oxygen-containing plasma feedstock, such as oxygen (O₂) gas, as outlined below. Importantly, these functional groups are present at the surface of the graphene (e.g. at the surface of the graphene particles) and are generally not present in the bulk of the material. Without wanting to be bound by any theory it is believed that, for multilayer graphene, functionalisation is restricted to the top 1 or 2 layers of the surface functionalised graphene particles.

Preferably, the surface-functionalised graphene particles are plasma-functionalised graphene particles (i.e. graphene which has been functionalised using a plasma-based process). Advantageously, plasma-functionalised graphene particles can display high levels of functionalisation, and uniform functionalisation, whilst limiting or avoiding damage to the structure of the graphene platelets and the introduction of unwanted impurities.

Plasma functionalisation of the graphene particles may be achieved using the methodologies taught in the applicant's earlier applications WO2010/142953, WO2012/076853, WO2022/058542, WO2022/058546 or WO2022/058218. For example, plasma functionalisation may be achieved as follows: the starting carbon material (e.g. graphite particles) are subjected to a particle treatment method in which the particles for treatment are subject to plasma treatment and agitation in a treatment chamber, most preferably by glow-discharge plasma. Preferably, the treatment chamber is a rotating container or drum. Preferably the treatment chamber contains or comprises multiple electrically-conductive solid contact bodies or contact formations, the particles being agitated with said contact bodies or contact formations and in contact with plasma in the treatment chamber.

Preferably, the contact bodies are moveable in the treatment chamber. The treatment chamber may be a drum, preferably a rotatable drum, in which a plurality of the contact bodies are tumbled or agitated with the particles to be treated. The wall of the treatment vessel can be conductive and form a counter-electrode to an electrode that extends into an interior space of the treatment chamber.

The plasma treatment may be glow discharge plasma treatment. In instances involving the use of contact bodies or contact formations, glow discharge plasma preferably forms on the surfaces of the contact bodies or contact formations.

The pressure in the treatment vessel is usually less than 500 Pa. Desirably, during the treatment, plasma-forming feedstock (gas or liquid) is fed to the treatment chamber and gas is removed from the treatment chamber through a filter. That is to say, it is fed through to maintain a chemical composition if necessary and/or to avoid build-up of contamination.

The treated graphene material, that is, the particles or disaggregated, deagglomerated or exfoliated components thereof resulting from the treatment, may be chemically functionalised by components of the plasma-forming gas, forming e.g. carboxy, carbonyl, hydroxyl functionalities on their surfaces. Plasma-forming gas in the treatment chamber may be or may comprise e.g. any of oxygen, water, hydrogen peroxide, alcohol (e.g. ethanol). Preferably the gas used is oxygen, to give graphene particles which are oxygen functionalised.

Plasma functionalisation may be used to precisely tune the degree of functionality present on the surface of the graphene, using relatively low amounts of power without using harmful chemicals. Plasma functionalisation using the methods taught above is also relatively mild, and can avoid the introduction of unwanted defects into the graphene particles.

Plasma functionalisation may be used to precisely tune the degree of functionality present on the surface of the graphene, whilst avoiding large amounts of other impurities being present in the surface-functionalised graphene particles. This includes impurities such as sulphur, NOₓ (various forms of nitrogen oxides, including NO, NO₂, N₂O) and manganese.

When wet chemical methods, such as the Hummers method are used to functionalise graphene, this can result in contamination of the graphene with impurities, in particular sulphuric acid residues. It is difficult to remove acid residues present on surface-functionalised graphene particles and even where these residues can be removed the removal is time consuming and requires high volumes of water producing large amounts of acidic waste.

Preferably, the surface-functionalised graphene particles comprise less than 0.2 wt %, preferably less than 0.15 wt % sulphur based on the total weight of surface-functionalised graphene particles (determined by XPS). Preferably, the total amount of sulphur impurities is less than 1 wt %, preferably less that 0.5 wt %, more preferably less than 0.2 wt % (determined by XPS). In contrast, levels of sulphur of up to 5 wt % can be present in graphene oxide obtained through wet chemical processes for graphene functionalisation such as the Hummers method. Sulphuric acid is known to be harmful to the types of metals common in heating systems employing heat transfer fluids, potentially causing/contributing to corrosion.

Plasma functionalisation also avoids unwanted nitrogen impurities in the form of nitric acid and NOₓ (various forms of nitrogen oxides, including NO, NO₂, N₂O), which may result from nitric acid used in wet chemical methods of functionalisation.

Preferably, the amount of nitric acid present in the surface-functionalised graphene particles is less than 10 ppm based on the total amount of surface-functionalised graphene particles, preferably less than 5 ppm, most preferably less than 1 ppm. Preferably, the amount of NOₓ present in the surface-functionalised graphene particles is less than 10 ppm, preferably less than 5 ppm, most preferably less than 1 ppm. The amount of nitric acid and NOₓ is determined by XPS. Impurities such as sulphur, nitric acid and NOₓ are left over from wet chemistry processes and not found in surface-functionalised graphene particles obtained by plasma treatment.

Plasma functionalisation also results in materials with lower (or no) levels of manganese contaminants than materials functionalised through the Hummers method. Preferably, the amount of manganese present in the surface-functionalised graphene particles is less than 10 ppm based on the total amount of surface functionalised graphene particles, preferably less than 5 ppm, most preferably less than 1 ppm (determined by XPS). Preferably, the total amount of manganese impurities is less than 0.1 wt %, preferably less that 10 ppm, more preferably less than 5 ppm, most preferably less than 1 ppm based on the amount of surface-functionalised graphene particles used in the heat transfer fluid (determined by XPS).

### Surfactant-Based Functionalisation

In addition, or alternatively, to surface functionalisation by oxygen-based functional groups, the graphene particles may be surface functionalised with surfactant molecules.

The surfactant may be selected from an anionic, cationic or nonionic surfactant.

Suitable surfactants include, for example, poloxamers (copolymers composed of a central hydrophobic chain of polyoxypropylene (PPG) flanked by two hydrophilic chains of polyoxyethylene (PEG)) such as poloxamer 407 (available under the brand name Pluronic™ F-127). Another suitable surfactant includes, for example, Rheobyk 7420 ES, availably from BYK.

Preferably, the graphene particles incorporate covalently-attached surfactant groups. To facilitate covalent attachment of the surfactant groups to the graphene particles, the graphene particles may be pre-treated to introduce suitable reactive groups to the surface, and the surfactants subsequently reacted with the surface groups.

For example, the reactive groups may be, for example, nitrogen-based reactive groups (e.g. amine or amide) or oxygen-based reactive groups (hydroxyl, carboxyl or carbonyl). These types of reactive group may be introduced through plasma functionalisation. Oxygen-based reactive groups may be introduced using the plasma-based methods taught above in relation to oxygen-functionalised graphene particles. Nitrogen-based reactive groups may be introduced by carrying out plasma treatment of graphene particles using ammonia or nitrogen as the plasma-forming feedstock.

The surfactants may be attached directly to the reactive groups. Alternatively, a coupling agent may be reacted with the reactive groups, and the surfactant subsequently reacted with the coupling agent.

### Base Fluid

Suitably, the base fluid comprises water. Optionally, the water is deionised water, to reduce the risk of mineral sediments forming in the system.

Optionally, the base fluid further comprises a glycol. The glycol may be, for example, ethylene glycol or properly glycol. Where present, glycol in the heat transfer fluid is preferably less than 50 vol % (volume % being the total volume of the heat transfer fluid). The amount of glycol may be, for example, 10 to 50 vol %, 20 to 50 vol %, or 20 to 40 vol %.

### Further Additives

The heat transfer fluid may comprise one or more further additives.

The further additive may be present in relatively minor amounts. For example, each further additive may comprise less than 5 wt %, less 4 wt %, less than 3 wt %, less than 2 wt %, or less than 1 wt % of the heat transfer fluid. The total amount of further additives may be, for example, less than 5 wt %, less 4 wt %, less than 3 wt %, less than 2 wt %, or less than 1 wt % of the heat transfer fluid. Where present, the further additive may be at least 0.1 wt %, or at least 0.5 wt % of the heat transfer fluid.

Said further additive may be a corrosion inhibitor. Corrosion (for example, rust formation) can lead to the build-up of dirt in heat transfer systems which can lead to blockages and significantly reduce thermal performance (since the thermal conductivity of the products of corrosion is much lower than the surface-functionalised graphene, and generally much lower than the materials used to make the heat transfer system). Over time, corrosion can lead to weakening of the heat transfer system to such an extent that leakages occur.

The corrosion inhibitor may be selected from the group consisting of inhibitors for preventing corrosion of iron, zinc, aluminium, copper, and combinations thereof. The corrosion inhibitor may be, for example, hydrazine, an amine (such as hexamine, phenylenediamine, and dimethylethanolamine, and their derivatives) or antioxidants such as sulphite and ascorbic acid.

Said further additive may be a stabiliser. The stabiliser acts to reduce sedimentation of components of the heat transfer fluid over time, including the surface-functionalised graphene particles. Accordingly, the stabiliser may alternatively be referred to as a sedimentation inhibitor. The stabiliser may be, for example, a surfactant. In instances where the graphene particles incorporate surfactant molecules on their surface, the surfactant used as a stabiliser may be referred to as “free surfactant” (i.e., not surface-bound). The stabiliser is preferably present at less than 5 wt %, less than 3 wt %, less than 2 wt %, less than 1 wt %, or preferably less than 0.5 wt %, the wt % being defined relative to the total weight of the heat transfer fluid. In preferred embodiments, the heat transfer fluid is substantially free of stabiliser (e.g. at a level of less 0.1 wt %, or less than 0.01 wt %).

pH

Generally, sedimentation of the particulate components (including the surface-functionalised graphene particles) will be sensitive to pH. Therefore, advantageously, the pH of the heat transfer fluid sits within a range which minimises sedimentation.

In practice, the pH of the heat transfer fluid generally sits in the range of 6.5 to 10. In the case where the pH of the heat transfer fluid is less than 6.5, the dispersion stability tends to be deteriorated. On the other hand, in the case where the pH of the heat transfer fluid is more than 10, there is a tendency for the composition to have such a high viscosity as to be difficult to use. Thus, preferably, the pH is within the range of 7.0 to 10.0, more preferably 7.0 to 9.0, most preferably still 7.0 to 8.0, which minimises sedimentation whilst also avoiding excessive viscosity.

In the case that the heat transfer fluid requires adjustment to more alkaline (that is, higher) pH, a base can be added. Examples of suitable bases include, an organic amine or ammonia. The neutralising agent may be selected from, for example, the group of ammonia, hydroxylamine, dimethylethanolamine (DMAE), ethylamine, diethylamine and triethylamine.

Generally, ammonia and DMAE are provided as aqueous compositions of from 25% to 50% concentration (w/w) in water. Addition of 0.1 wt % aqueous ammonia (50 wt % concentration) is therefore the molar equivalent of the addition of 0.05 wt % anhydrous ammonia. Similarly, the addition of 0.1 wt % aqueous DMAE (25 wt % concentration) is the molar equivalent of addition of 0.025 wt % anhydrous DMAE.

In instances where the pH of the solution needs to be reduced, acids may be used, such as an organic acid or a mineral acid.

### Amount of Components

If the amount of surface-functionalised graphene particles is too high, this can increase the viscosity of the fluid and thereby increase the energy required to circulate the heat transfer fluid within a heat system. Therefore, the heat transfer fluid preferably comprises no more than 10 wt %, for example no more than 8 wt %, ono more than 5 wt %, or no more than 2 wt % of the surface-functionalised graphene particles.

If the amount of surface-functionalised graphene particles is too low, the heat transfer performance boost may be limited. Accordingly, it is preferred that the heat transfer fluid comprises at least 0.1 wt %, at least 0.5 wt %, or at least 1 wt %, the weight percentages being given relative to the total weight of the heat transfer composition.

Preferred ranges for the amount of surface-functionalised graphene particles in the heat transfer fluid may be, for example, 0.1 to 10 wt %, 0.1 to 8 wt %, 0.1 to 5 wt %, preferably 0.1 to 4 wt %.

When expressed as a vol %, the amount of surface-functionalised graphene particles in the heat transfer fluid may be, for example, no more than 5 vol %, no more than 4 vol %, no more than 3 vol %, or no more than 2 vol %. The lower limit for the amount of surface-functionalised graphene particles may be, for example, at least 0.05 vol %, at least 0.1 vol %, at least 0.2 vol %, or at least 1 vol %. The range may fall, for example, between 0.1 to 5 vol %, 0.1 to 4 vol %, 0.1 to 3 vol %, optionally 0.1 to 2 vol % or 0.1 to 0.5 vol %.

Optionally, the heat transfer fluid consists substantially of (or consists entirely of) said surface-functionalised graphene particles and water. In other words, the heat transfer fluid does not include any components other than the surface-functionalised graphene particles and water. For example, the heat transfer fluid may consist of 0.1 to 0.5 vol % surface-functionalised graphene particles in water.

In the heat transfer fluid according to the present invention the balance of components is generally made up to 100% with water.

The viscosity of the heat transfer fluid may be, for example, no more than 30 mPa s⁻¹ or no more than 20 mPa s⁻¹. If the viscosity is too excessive, this can increase the energy required to pump the heat transfer fluid around the system. Preferably the heat transfer fluid composition has a viscosity value of more than 0.1 mPa s⁻¹, or more than 0.5 mPa s⁻¹. For example, the heat transfer fluid may have a viscosity in the range of 0.1 to 20 mPa s⁻¹, such as in the range of 0.5 to 5 mPa s⁻¹, preferably 0.5 to 1.5 mPa s⁻¹. Unless otherwise stated, all viscosity values correspond to the viscosity measured at 20° C. using a dynamic sheer rheometer (such as a Kinexus DSR, available from Nesus Analytics).

### Concentrated Form

The heat transfer fluid may be provided in a concentrate form for subsequent dilution into a heating system. When present in a concentrate form, the heat transfer fluid may contain, for example, at least 5 wt % surface-functionalised graphene particles, at least 10 wt %, at least 15 wt %, at least 20 wt %, or at least 25 wt %. The upper limit for the amount of surface-functionalised graphene particles in the concentrate form may be, for example, 30 wt %, or 40 wt %. Advantageously, increasing the amount of surface-functionalised graphene particles in the concentrate reduces the amount of the fluid which must be added to a thermal management system. However, if the amount of surface-functionalised graphene particles is too high, the viscosity of the concentrate becomes too high to allow easy handling and mixing when forming the final heat transfer fluid.

Preferably, the concentrate consists of the surface-functionalised graphene particles dispersed in water (most preferably deionised water), optionally with a stabiliser. This concentrate can be diluted in water, together with any additional components (such as glycol, corrosion inhibitor).

### Uses

The present invention also provides use of surface-functionalised graphene particles to improve the thermal performance of a heat transfer fluid.

The invention also provides use of a dispersion of surface-functionalised graphene particles to improve the thermal performance of a thermal management system. The thermal management system may be, for example, a central heating system (such as a domestic central heating system based on a gas boiler or heat pump system), a car radiator system, a plate heat exchanger system, an electronic cooling system, a refrigeration system, or an air conditioning system. Preferably, the thermal management system is a central heating system, such as a gas central heating.

### Thermal Management Systems

In another aspect, the present invention provides a thermal management system, comprising a heat transfer fluid of the present invention. The thermal management system may comprise a closed loop having a heater fluidly connected to one or more radiators or plate heat exchangers, wherein the closed loop is filled with a heat transfer fluid of the first aspect. The thermal management system may be, for example, a central heating system, such as a domestic central heating system.

### Methods of Making a Heat Transfer Fluid

The heat transfer fluid may be prepared by dispersing the graphene particles in the base fluid to form a dispersion.

The method may involve sonicating the dispersion. Preferably, the sonication is relatively high intensity sonication. This may be achieved, for example, using a cascade sonotrode (sometimes referred to as a cascatrode). Advantageously, sonication also helps to break apart the sheets of the (turbostratic) surface-functionalised graphene particles into smaller flakes, helping to decrease their thickness and thereby boost the aspect ratio of the particles.

Optionally, the method may involve a separation step to remove any non-dispersed filler and/or break apart the filler into smaller parts, e.g. by centrifugation. Such a step is known from other heat transfer fluids, where such a step is usually necessary in order to remove filler which has not properly dispersed. However, advantageously, the present inventors have found that the surface-functionalised graphene used in the invention can be dispersed sufficiently efficiently that a separation step is not carried out. Therefore, the method may lack a separation step (e.g. lack a separation step before/after a sonication step).

### Preferably, the Method Involves:

1. treating a graphene precursor (e.g. graphite particles) with a plasma to form oxygen-functionalised graphene particles;
2. dispersing the oxygen-functionalised graphene particles in a base fluid to form a dispersion; and
3. preferably, sonicating the dispersion.

Any further additives may be added at any appropriate point, for example, to the base fluid before step (2), to the dispersion after step (2), or after step (3).

For surfactant-functionalised particles, the method may involve:
A. treating a graphene precursor (e.g. graphite particles) with a plasma to form surface-functionalised graphene particles with reactive groups at their surface;
B. reacting the reactive groups of the surface-functionalised graphene particles so as to attach the surfactant to form surfactant-functionalised graphene particles;
C. dispersing the surfactant-functionalised graphene particles in a base fluid to form a dispersion; and
D. preferably, sonicating the dispersion.

The surfactant may be reacted directly with the reactive groups. Alternatively, the method involves a step (A2) after step (A) involving reacting the reactive group with a coupling agent, which coupling agent is subsequently reacted with the surfactant to form the surfactant-functionalised graphene particles.

Any further additives may be added at any appropriate point, for example, to the base fluid before step (C), to the dispersion after step (C), or after step (D).

### Examples

In the following examples, the thermal conductivity of various heat transfer fluids was measured.

### Apparatus and Conditions

The thermal conductivity of samples was measured using a Hot Disk® Instrument TPS 3500, in which the sensor switch was a 4-ports switch, and the sensor used was 7577 F1 Kapton (radius 2 mm). Carbolite LHT4/30 was used as a fan furnace for heating the samples.

Each sample was heated to 80° C. as the target temperature. 5 measurements were taken for each sample using the isotropic standard module of the TPS instrument. The time of each measurement was 5 s and the heating power during each measurement was 0.04 W. Each sample was sonicated prior to the measurement of its thermal conductivity, and reagitated immediately before the measurement.

Surface-functionalisation of materials was carried out using the apparatus and conditions as taught in WO2012/076853, forming a plasma in a rotatable plasma chamber using an oxygen feedstock, with steel ball bearings present in the chamber. Unless stated otherwise, graphene functionalised under these conditions has a resulting surface oxygen level between about 4 atom % and about 8 atom % (i.e., 4-8 atom %). By providing a surface oxygen level of 4-8 atom %, samples were found to generally be stable and exhibit desirable thermal conductivity effects. The surface oxygen level may be measured, for example, by XPS as described herein.

### Samples Tested

The following materials are referred to in Table 1:

FLG 5 μm: Few-layered graphene particles (platelets) with an average major dimension of 5 μm, functionalised to 4-8 atom % surface oxygen using the above-mentioned protocol.

FLG 7 μm: Few-layered graphene particles (platelets) with an average major dimension of 7 μm, functionalised to 4-8 atom % surface oxygen using the above-mentioned protocol.

POGO: Plasma-oxidised graphene oxide with an average major dimension of less than 2 μm and with about 28 atom % surface oxygen.

Unless specified otherwise, the base fluid used was deionised (DI) water.

### Results

The results of the abovementioned measurements are displayed in Table 1.

TABLE 1

| | | Amount in | Thermal |
|---|---|---|---|
| | | dispersion | conductivity |
| Sample | Particles | (wt %) | (W/mK) |
| 1 | None | 0 | 0.43 |
| 2 | FLG 5 μm | 3.3 | 0.78 |
| 3 | FLG 5 μm | 7.5 | 0.95 |
| 4 | FLG 7 μm | 1.5 | 0.55 |
| 5 | POGO | 0.5 | 0.46 |

Sample 1 corresponds to deionised water with no additives or particles. As can be seen from the results in Table 1, there is a significant improvement in the thermal conductivity of a heat transfer fluid comprising graphene particles with 4-8 atom % surface oxygen (Samples 2, 3 and 4). The best thermal conductivity was obtained in a heat transfer fluid comprising 7.5 wt % FLG 5 μm (4-8 atom % surface oxygen), but improved thermal conductivity is achieved even with only 3.3 wt % FLG 5 μm (4-8 atom % surface oxygen) or 1.5 wt % FLG 7 μm (with 4-8 atom % surface oxygen), when compared to DI water.

Hence it is possible to achieve significant increases in thermal conductivity using the graphene-based materials of the present invention at low incorporation amounts, thereby avoiding extra cost and minimising changes in the flow properties of the thermal fluid compared to DI water.

Sample 5 contained surface-functionalised graphene oxide particles with 28 atom % surface oxygen. When the particles have a high surface oxygen level such as this, the improvement in thermal conductivity compared to water, although still present, is less than is seen for particles with 4-8 atom % surface oxygen. Without being bound by theory, it is thought that when a very high degree of surface-functionalisation is present, the intrinsic thermal conductivity of the graphene particles is impinged, and the resulting heat transfer fluid shows less of an improvement.

Testing was also carried out using pristine (i.e., unfunctionalized) graphene particles in DI water as a heat transfer fluid, but it was impossible to obtain a stable dispersion. Without being bound by theory, it is thought that the absence of surface-functionalisation made it impossible to disperse the particles. Hence, there is no measurement shown in the results corresponding to this sample, but its thermal conductivity is identical to DI water (sample 1) since the particles simply deposit at the bottom of the container. Such a sample would not be useful as a heat transfer fluid because it would result in unwanted agglomeration and deposits in heating/cooling systems.

Therefore, the above measurements clearly show that the use of surface-functionalised graphene particles can result in an improved heat transfer fluid displaying excellent thermal conductivity, for example to be used in a heating/cooling system.

1. Use of surface-functionalised graphene particles to improve the thermal performance of a heat transfer fluid.

2. Use according to claim 1, wherein the surface-functionalised graphene particles have oxygen-based functional groups attached to their surface.

3. Use according to claim 2, wherein the surface oxygen level is between 1 to 20 atom %.

4. Use according to claim 2, wherein the surface oxygen level is between 3 to 9 atom %.

5. Use according to claim 1, wherein the surface-functionalised graphene particles have surfactant attached to their surface.

6. Use according to claim 5, wherein the surfactant is covalently attached to the graphene particles.

7. Use according to any one of the preceding claims, wherein the median number of layers of the surface-functionalised graphene particles is between 1 and 5.

8. Use according to any one of the preceding claims, wherein the surface-functionalised graphene particles have a major dimension which is at least 500 times the size of their thickness.

9. Use of a dispersion of surface-functionalised graphene particles to improve the thermal performance of a thermal management system.

10. Use according to claim 9, wherein the thermal management system is a central heating system.

11. A heat transfer fluid comprising graphene particles dispersed in a base fluid, wherein the graphene particles have a surface oxygen level of between 3 to 9 atom %.

12. A heat transfer fluid comprising graphene particles dispersed in a base fluid, wherein the graphene particles have surfactant bound to their surface.

13. A heat transfer fluid according to claim 12, wherein the surfactant is covalently bound to the particle surface.

14. A heat transfer fluid according to any one of claims 11 to 13, wherein the base fluid is water.

15. A heat transfer fluid according to any one of claims 11 to 14, wherein the base fluid comprises a mix of water and glycol.

16. A heat transfer fluid according to any one of claims 11 to 15, further comprising a corrosion inhibitor.

17. A heat transfer fluid according to any one of claims 11 to 16, further comprising a stabiliser.

18. A heat transfer fluid according to claim 17, wherein the stabiliser is a surfactant.

19. A heat transfer fluid according to any one of claims 11 to 13, consisting of said graphene particles and water.

20. A thermal management system, comprising a heat transfer fluid according to any one of claims 11 to 19.

21. A thermal management system according to claim 20, wherein the thermal management system is a central heating system.

22. A method of making a heat transfer fluid, the heat transfer fluid comprising a dispersion of oxygen-functionalised graphene particles in a base fluid; the method comprising:
1. treating a graphene precursor with a plasma to form oxygen-functionalised graphene particles; and
2. dispersing the oxygen-functionalised graphene particles in a base fluid to form said dispersion.

23. A method of making a heat transfer fluid, the heat transfer fluid comprising a dispersion of surfactant-functionalised graphene particles in a base fluid; the method comprising:
A. treating a graphene precursor with a plasma to form surface-functionalised graphene particles with reactive groups at their surface;
B. reacting the reactive groups of the surface-functionalised graphene particles so as to attach the surfactant to form surfactant-functionalised graphene particles;
C. dispersing the surfactant-functionalised graphene particles in a base fluid to form a dispersion; and
D. preferably, sonicating the dispersion.
